(19) United States
(12) Patent Application Publication
(10) Pub. No.: US 2019/0127950 A1
(43) Pub. Date: May 2, 2019

(54) MATERIAL-COLLECTING CONTAINER OF A SUCTION DREDGER

(71) Applicant: RSP GMBH, Saalfeld (DE)

(72) Inventors: Karl-Heinz RENGER, Saalfelder Hoehe (DE); Marina RENGER, Saalfelder Hoehe (DE); Jens GRABER, Saalfelder Hoehe OT Unterwirbach (DE)

(21) Appl. No.: 16/090,494

(22) PCT Filed: Mar. 22, 2017
(86) PCT No.: PCT/EP2017/056883

§ 371 Date: Oct. 1, 2018

(30) Foreign Application Priority Data
Mar. 31, 2016 (DE) 10 2016 105 850.5

(51) Int. Cl. E02F 3/88; B60P 1/16; E02F 3/94; E02F 9/08

(52) U.S. Cl. CPC E02F 3/8816; E02F 9/0883; E02F 3/94; B60P 1/165

(57) ABSTRACT

The invention relates to a material collection container of a suction excavator, having a suction connection at its rear end-face wall and a suction flow duct that leads from the suction connection through a collection chamber and a filter unit. The suction connection is positioned at the rear end-face wall in such a way that its cross section is intersected by the plane of symmetry of the material collection container. After passing through the collection chamber, the suction flow is divided into at least two subflows that are conducted in air ducts situated on both sides of the plane of symmetry.

The invention further relates to a suction excavator having this type of material collection container.

### FIELD

The present invention relates to a material collection container of a suction excavator. Such material collection containers have a suction connection, usually at their rear end-face wall, and a suction flow duct that leads from the suction connection through a collection chamber and a filter unit.

### BACKGROUND

A suction excavator that uses this type of material collection container is a vehicle having a vehicle chassis with a vehicle longitudinal axis that extends in a vehicle center plane. A dumpable material collection container that is suspended on a tilt axis extending in parallel to the vehicle longitudinal axis is typically used. In advantageous designs, such a suction excavator has a telescoping device with two telescoping arms whose ends on the container side are each situated on the tilt axis about which the material collection container is thus rotatable, the end of each telescoping arm on the chassis side being situated on the vehicle chassis. The unit comprising the material collection container and its bearing and actuating elements may preferably be designed in the form of an emptying module that can be operated on a vehicle and, as necessary, also in stationary operation without the vehicle.

In conjunction with utility vehicles and trucks, it is known to provide superstructures on a vehicle chassis for the particular intended purpose, which are adapted to a greater or lesser extent to the mobile application. Such superstructures are connected to the vehicle chassis; in certain applications the vehicle main drive is also utilized as a drive unit for auxiliary functions, but occasionally the superstructures are also operational independently from the vehicle. For example, trucks for bulk material that bear a receiving container for material are known, in which for unloading the bulk material the receiving container is tipped about a tilt axis so that the bulk material is led out of the container due to the force of gravity.

A suction excavator is known from DE 38 37 670 A1, including a pneumatic suction nozzle, a collection container for the suctioned-in soil, into which the suction nozzle opens and in which the soil is separated from the suction air flow, and a suction fan, connected to the collection container, for generating the suction air flow. Further customary components of the suction excavator include guide elements for the suction nozzle, and filters for cleaning the suction air before it leaves the collection container and is released to the surroundings. In the design of the suction excavator described in this publication, a collection container is used which alternatively may be tipped toward the particular side of the vehicle, in each case about one of two tilt axes extending in the longitudinal direction of the vehicle, in order to empty out the material that is deposited in the collection container. The tilting arrangement that is used corresponds, to the greatest extent possible, to the design of trucks with dumper troughs. One disadvantage of such lateral dumping of the collection containers is that the received material falls to the ground directly next to the vehicle, and with larger material quantities it may be difficult to completely empty the material collection container in just one tilting operation. Therefore, the vehicle must either be moved during the tilting operation, or the dumping of the material must take place in a deeper-lying area to thus be able to receive larger material quantities.

A tiltable container, in particular for suction excavators, is known from DE 10 2012 003 226 A1, in which the tilt axis is situated above the container base, preferably in the top half of the container. The suction connection at which a suction tube is connectable to the material collection container is located at the side of the rear end-face wall of the material collection container. To empty the container, with the aid of a hydraulic system the container may initially be lifted and shifted laterally so that the tilt axis is moved into an elevated position. A second linear drive then acts on the container in order to swivel it about the tilt axis. Prior to the emptying operation, a cover situated on the container must be opened by a dedicated hydraulic system and swiveled to the side to allow the container to be lifted and tipped. The design of this suction excavator is correspondingly complicated, maintenance-prone, and costly. In addition, the previously known suction excavator has the major disadvantage that the container is tiltable only toward one side of the vehicle, which significantly limits the flexible use of the suction excavator.

DE 10 2011 119 924 A1 discloses a suction excavator for receiving suction material, such as soil or sludge, having a pneumatic suction turbine, for generating a suction air flow, that is connected to a collection container into which a suction hose opens. The suction hose is situated on a guide arm, which is fastened to a vertical rotational axis in order to expand the working range of the suction excavator. Two suction hose connections are provided on the material collection container, each of which opens into the collection container at the outer side area of a rear end-face wall. Although the swivel arm which is fastened via the rotational axis allows an expansion of the working range on both sides of the vehicle, it results in a significant increase in the overall length of the suction excavator, and a less favorable location of the center of gravity of the vehicle. In addition, it is necessary to fasten the suction hose to the particular connection that is required. When there is a change in the work situation, the suction hose must be removed and installed on the other suction connection. The required sealing in each case of the unused suction opening on the material collection container results in an increased level of effort.

DE 198 51 111 C1 describes a suction excavator, having a collection chamber with a filter situated in the front of the material collection container in the travel direction and in the rear of the material collection container in the travel direction. The connection of the suction tube to the material collection container once again takes place on one side of the rear end of the collection container. Although this allows a broad working range on the side close to the suction connection, it limits the working range on the other side. As a result of the selected suction flow duct, this results in asymmetrical deposition of the material in the collection chamber as well as poor pre-separation of material from the suction flow.

A suction excavator is also described in DE 299 02 562 U1. This suction excavator operates according to the thin stream conveying principle, and is configured primarily for receiving excavated soil.

DE 10 2014 103 604 B3 discloses a suction system for generating a suction flow within a suction flow line by means of a ventilator system and a pump system that are situated in the suction flow line. The ventilator system is situated within a first internal air duct for conducting a first partial suction flow, while the pump system is situated within a second internal air duct for conducting a second partial suction flow in parallel to the ventilator system in terms of air flow. The suction flow portions generated by means of the ventilator system and the pump system are adjustable.

U.S. Pat. No. 3,930,324 A describes a mechanical hole digging machine comprising a rotary cutting tool and a suction tube having an inlet opening adjacent to the cutting tool. The suction tube is connected to a suction device. The material removed by the cutting tool passes into a collection chamber due to the suction effect.

DE 295 08 516 U1 relates to a suction system for excavating supply ducts. The suction system comprises a movable cantilever arm that is mounted on a vehicle. A collection container having a closure plate that is movable on the bottom side is situated on the cantilever arm. Downwardly protruding support legs are mounted on the collection container at a lateral distance from a bottom side apex.

A mobile multistage particle separator is known from U.S. Pat. No. 4,062,664 A, which includes a cyclone separator for separating heavy particles. After passing through the cyclone separator, the air and the lighter particles contained in the air are accelerated by means of a nozzle and supplied to a linear separator through an opening. The air flows downwardly in the linear separator, and lighter particles are separated. The air that is freed of the lighter particles flows upwardly, the air stream being divided into two substreams. The substreams leave the opening in the linear separator and are conducted in such a way that they do not intersect the inflowing air stream. The substreams are subsequently each led into a vertical air duct. The air ducts extend on both sides of the linear separator. The substreams subsequently reach the top via filter chambers, and the lightest particles contained in the substreams are filtered out. After passing through the filter chambers, the substreams are each led into a horizontal duct situated at the upper end of the filter chamber. The horizontal ducts are connected to a duct, which in turn is connected to a fan of the particle separator. The clean air is supplied to the fan.

### SUMMARY

The object of the present invention is to provide an improved material collection container for a suction excavator, which on the one hand provides an essentially equal working range on both sides of the suction excavator, and on the other hand allows improved separation of the received material from the suction flow, this material being deposited essentially symmetrically with respect to the vehicle longitudinal axis of the suction excavator in order to avoid an asymmetrical load on the vehicle, also when the material collection container is filled.

These and further objects are achieved by a material collection container according to appended claim 1. In addition, the stated object is achieved by a suction excavator according to appended claim 7 that makes use of such a material collection container.

The material collection container according to the invention is characterized in that firstly, the suction connection to which the suction hose is connected is positioned at the rear end-face wall of the material collection container in such a way that the plane of symmetry of the material collection container extends through the cross-sectional area of the suction connection. In particular, the midpoint of the opening in the suction connection lies on an axis situated in or near the plane of symmetry of the material collection container. In addition, the material collection container is designed in such a way that the suction flow that results during operation

after passing through the collection chamber is divided into at least two subflows, which are conducted in air ducts situated on both sides of the plane of symmetry.

According to one preferred embodiment, the air ducts on both sides extend on each of the longitudinal side walls of the material collection container, so that for the stated central conduction of the suction flow at the suction connection, a uniform distribution into two subflows takes place, and the flow continues with essentially the same volume in the preferably identical side air ducts. As a result, the material contained in the suction flow is deposited with an essentially symmetric distribution in the collection chamber before the subflows pass into air ducts at the side walls of the material collection container.

In one particularly advantageous embodiment, the plane of symmetry of the material collection container in an untipped state of the material collection container is situated essentially in the vehicle center plane, so that the achieved symmetry in the material collection container at the same time maintains the desired symmetry of the overall vehicle.

The air ducts are preferably recombined outside the collection chamber, preferably in front of the front end-face side of the material collection container in the travel direction, so that they jointly open into the inlet of a suction fan of the suction excavator. This joint inlet of the suction fan is preferably likewise situated in the center plane of the vehicle, so that the symmetry is also maintained at this location.

Depending on the embodiment of the material collection container, the collection chamber may be situated in front of or behind the filter unit, based on the travel direction of the suction excavator.

One preferred embodiment of the material collection container has a cover that has at least a two-part design. Each cover part is fastened to a folding axis situated in the plane of symmetry of the material collection container, so that in each case approximately one-half of the top side of the material collection container can be opened when it is tipped for emptying. Preferably no sections of the air ducts extend in the cover, so that the cover may have a simple and robust design.

In its longitudinal direction the material collection container particularly preferably has an essentially symmetrical design, in particular from the standpoint of load distribution. Within the meaning of the present invention, a symmetrical design may be assumed when the material collection container, suspended along a tilt axis and without use of any other fastening or bearing elements, automatically swivels into a position in which the center plane is essentially vertical, and the top side of the material collection container extends essentially in a horizontal plane. Those skilled in the art will recognize that a symmetrical design in this sense is also provided when additional elements, for example elements that are necessary for the fastening or other secondary functions, are mounted on only one side of the material collection container, and in this respect no strict geometric symmetry is provided.

The invention further relates to a suction excavator having this type of material collection container. The material collection container is preferably fastened to the vehicle in such a way that it may be dumped. In particular, dumping of the material collection container on both sides of the vehicle is made possible. At the same time, it is advantageous when an elevated position of the tilt axis is provided to allow emptying of the material collection container onto surfaces at different heights, for example an adjacent vehicle.

One preferred design of the suction excavator is characterized, among other things, in that the tilt axis extends in parallel to the plane of symmetry of the material collection container, the lateral offset with respect to the plane of symmetry being less than ⅛, preferably less than 1/12, of the width of the material collection container. The tilt axis particularly preferably extends in the plane of symmetry of the material collection container, which encompasses the vehicle longitudinal axis in an idle, working, or transport state.

Furthermore, one embodiment of the suction excavator is characterized in that the ends of the telescoping arms on the chassis side are particularly preferably pivotably fastened to the vehicle chassis in the vehicle center plane, or with only a slight lateral offset with respect to same which is less than ⅛, preferably less than 1/12, of the width of the material collection container. As a result, the telescoping arms in an idle or transport state, i.e., with the material collection container not tilted, are essentially vertical and likewise extend in the vehicle center plane. This also has the advantage that the weight force in this idle, working, and transport state, originating from the material collection container and the material present therein, acts on the telescoping arms in the axial direction, which in this direction are able to absorb large forces, provided that the material collection container is not set down on the chassis. Lastly, the telescoping arms may thus have a less massive design, since in particular when the vehicle moves over uneven terrain, large acceleration forces originate from the material collection container and the received material and act in the longitudinal direction of the telescoping arms, and may thus be readily absorbed. Although transverse forces also act on the telescoping arms during an emptying operation, as described below, at that moment the vehicle is at rest, so that the resulting overall forces are not increased by additional impulses.

According to one preferred embodiment, the suction excavator has at least one rotary drive on the container-side end of at least one of the telescoping arms. The rotary drive acts on the material collection container in order to rotate it about the tilt axis for an emptying operation. Linear drives that act separately between the material collection container and the vehicle chassis may thus be dispensed with. In order to apply larger forces and bring about synchronization, in one preferred embodiment two rotary drives, respectively situated on the container-side end of the two telescoping arms, may be utilized.

Lastly, the suction excavator preferably has one or more slew drives that allow the telescoping arms to swivel out of the vehicle center plane in both angular directions. The slew drive may be designed as hydraulic cylinders, for example, that act between the vehicle chassis and the section of the telescoping arm that is not changeable in length. In alternative embodiments, the slew drive may be designed as a further rotary drive that preferably engages with both telescoping arms on the chassis-side end. The slew drive may also utilize other linear drives that optionally act oppositely to one another to allow swiveling in both directions on the side of the vehicle.

Since the connection for the suction hose is provided on the material collection container in such a way that an essentially symmetrical input of the drawn-in material takes place, and the air discharge from the collection container likewise takes place symmetrically, the load distribution in the material collection container is likewise essentially symmetrical, regardless of the filling state.

It is advantageous when the tilt axis of the material collection container extends through two pivot bearings situated on the end-face walls of the material collection container running transversely with respect to the travel direction. These pivot bearings are particularly preferably situated on the end-face walls in the top half of the material collection container, so that in the idle state, the tilt axis is already situated considerably above the chassis, for example at a height of approximately 2 to 3 m above the road surface level. One of the pivot bearings may have a simple design as a journal bearing.

In one modified embodiment, the pivot bearings are combined with a ball joint that acts in the axial direction, so that a height offset may occur between the oppositely situated pivot bearings, in particular when the telescoping arms are extended, without resulting in blockage of the pivot bearing. When the pivot bearings refined in this way as well as the remaining design allow such a height offset to be purposely set, the tilt axis may be inclined with respect to the vehicle chassis in the longitudinal direction, so that, for example, in the event of a vehicle that is inclined when stationary, it is still possible to carry out virtually horizontal dumping of the material collection container, or in a modified case to also carry out a targeted displacement of the material collection container with respect to the horizontal, for example to allow liquid or pulpy media to flow out on only one side of the material collection container.

In the embodiment having a cover situated on the top side of the material collection container, the cover is opened for emptying. During dumping of the material collection container, the cover half is opened on the side of the vehicle toward which the material collection container is dumped. It is advantageous when opening, closing, and locking elements are provided to open the cover and to tightly close it during the suction operation, so that the pressure conditions in the material collection container meet the requirements for a suction excavator.

In one preferred embodiment, the telescoping arms of the suction excavator is designed in such

a way that the difference in the lengths between the completely retracted state and the completely extended state is at least ¼, preferably approximately ½, of the height of the material collection container. This ensures that the material collection container may be lifted high enough so that no other parts of the vehicle are damaged during the subsequent tipping. At the same time, by an appropriately wide extension of the telescoping arms it may be ensured that emptying at a higher level remains possible.

The lateral swiveling of the telescoping arms should be possible at least to the extent that sale dumping of the material collection container on the particular side of the vehicle is possible without the vehicle being damaged, or the material which is falling out being hindered in its continued travel. The telescoping arms may preferably be swiveled wide enough with respect to each side of the vehicle that the tilt axis, projected onto the plane of the vehicle chassis, extends outside the base area described by the vehicle chassis.

### BRIEF DESCRIPTION OF THE DRAWINGS

Further particulars, advantages, and refinements of the present invention result from the following description of one preferred embodiment, with reference to the drawings, which show the following:

FIG. 1 shows a simplified side sectional view of a suction excavator with a material collection container according to the invention, in a first embodiment;

FIG. 2 shows the material collection container of the first embodiment in a perspective view;

FIG. 3 shows a simplified side sectional view of a suction excavator with a material collection container according to the invention, in a second embodiment;

FIG. 4 shows the material collection container of the second embodiment in a perspective view;

FIG. 5 shows a simplified view of the suction excavator from the rear;

FIG. 6 shows a perspective view of an emptying module of the suction excavator with the material collection container tilted; and

FIG. 7 shows a view of the suction excavator from the rear during an emptying operation.

### DETAILED DESCRIPTION

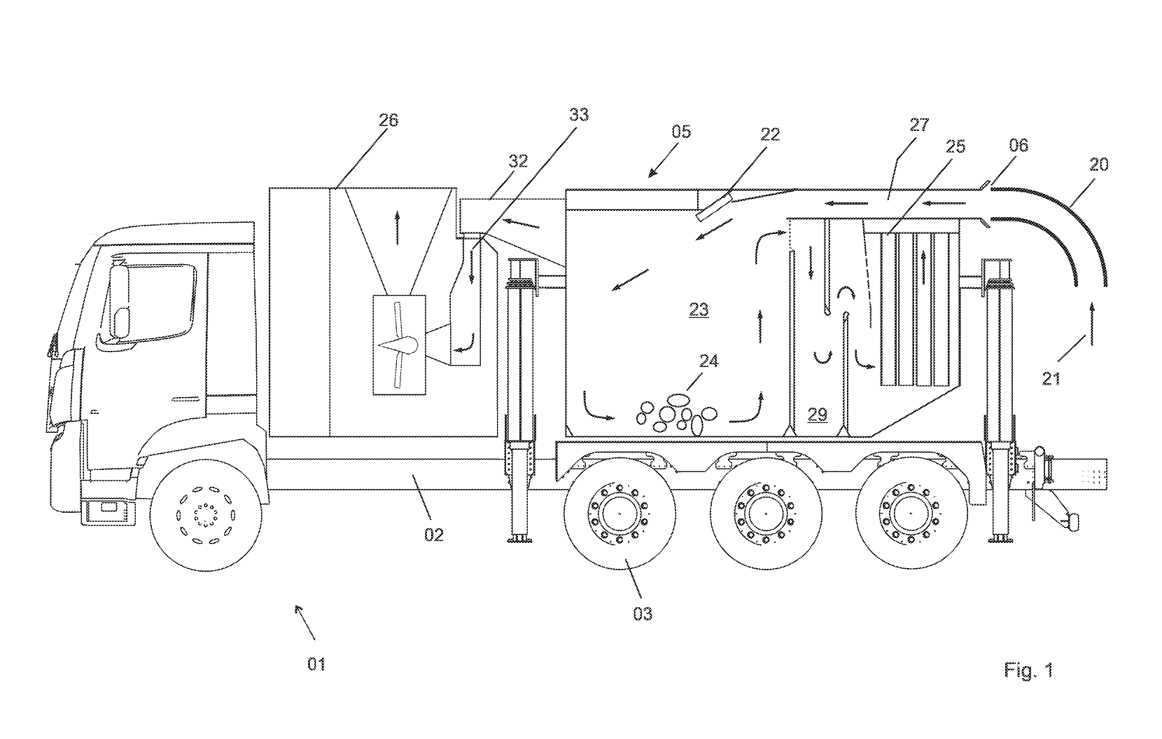

FIG. 1 shows a simplified, partially sectional side view of a suction excavator 01, which first of all typically includes a vehicle chassis or an auxiliary frame 02 and multiple vehicle wheels 03. In addition, the suction excavator includes a material collection container 05 according to the invention which is mounted on the vehicle chassis 02. Provided on the rear end-face side of the material collection container 05 is a suction connection 06, to which a suction hose 20 is connected. Material is drawn in at the free end of the suction hose 20 with the aid of a suction flow 21, symbolized by flow arrows.

In the embodiment illustrated in FIG. 1, the suction flow 21 initially travels in the upper area of the material collection container 05 in an upper air duct 27 until reaching a baffle plate 22, where it is deflected into a collection chamber 23. Due to the increase in volume, the flow velocity in the collection chamber 23 decreases, so that material 24 is deposited in the collection chamber. The suction flow then passes into a filter unit 25, in which smaller particles still present in the suction flow are filtered out. In the illustrated embodiment, the collection chamber 23 is situated in front of the filter unit 25 in the travel direction.

The suction excavator 01 also bears a suction fan 26, positioned in front of the material collection container 05 in the travel direction, which generates the air stream for forming the suction flow 21.

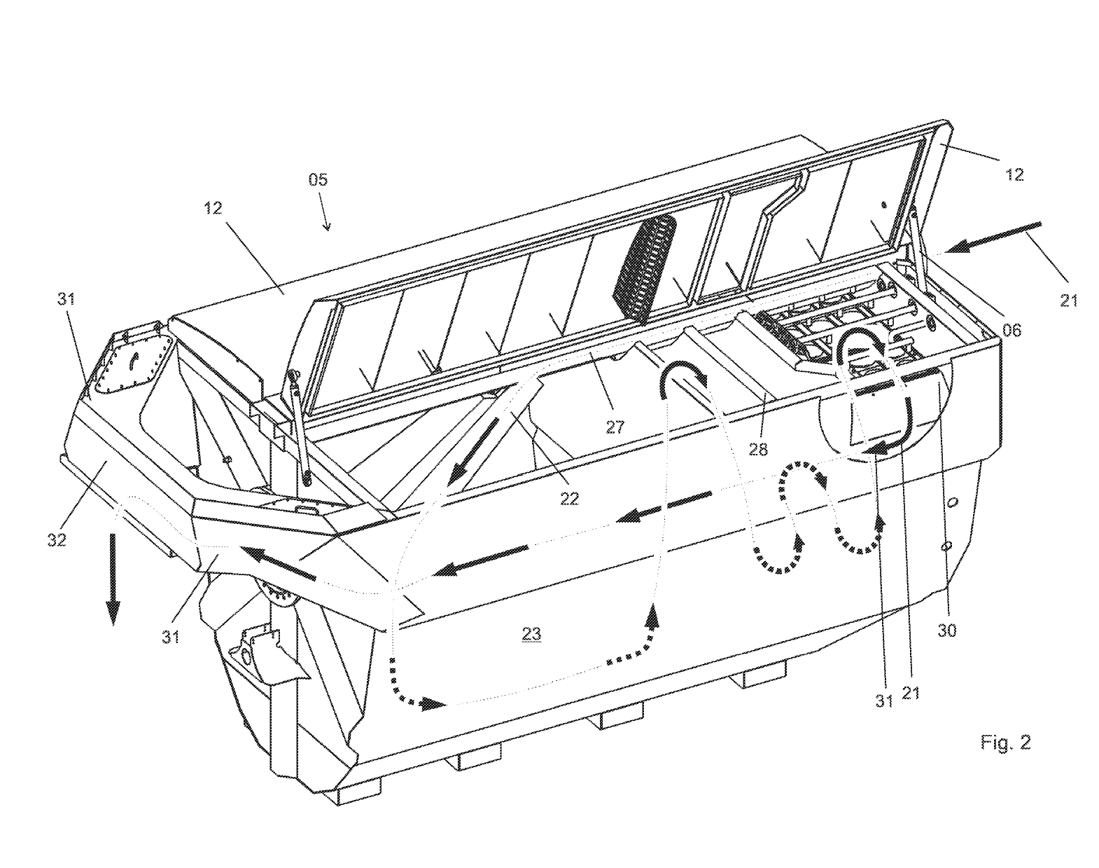

FIG. 2 shows a perspective, partially sectional view of the material collection container 05 according to the embodiment illustrated in FIG. 1. It is apparent first of all that the material collection container 05 on its top side is closed by a cover 12 made up of two cover parts. The cover half situated on the left in the travel direction is illustrated in the open state, while the cover half situated on the right in the travel direction is closed. The flow arrows indicate the course of the suction flow 21, which initially enters the suction connection 06 at the rear end-face wall and travels in the upper air duct 27 until reaching the baffle plate 22, where it is introduced into the interior of the collection chamber 23. The suction flow passes over multiple baffles 28 of a pre-separator 29 and to the filter unit 25. The suction flow 21 leaves the filter unit 25 on both sides of the material collection container 05, in each case through a side outlet 30, and at that location enters a side air duct 31. The two side air ducts 31 run on the respective left and right side walls of the material collection container 05. The two side air ducts 31 are combined into a front air duct 32 at the front end-face side of the material collection container 05. The front air duct 32 opens into the inlet 33 of the suction fan 26 (FIG. 1).

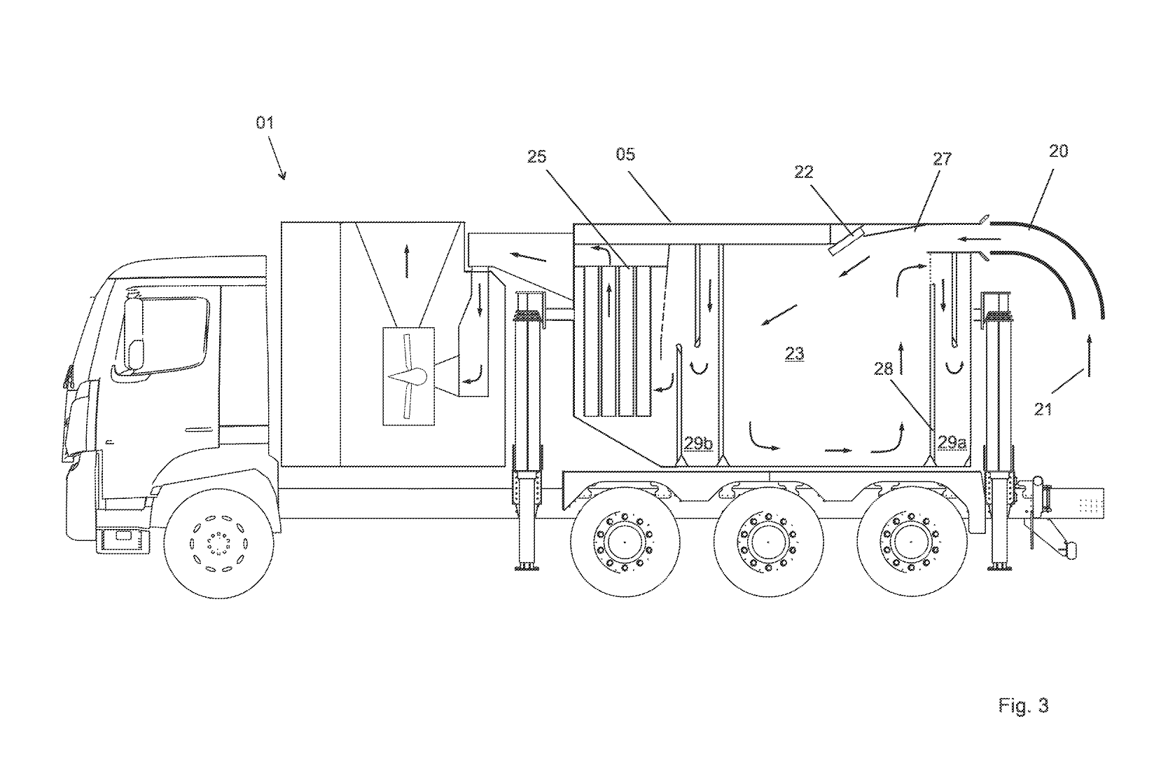

FIG. 3 shows a modified embodiment of the suction excavator with an altered material collection container 05. The change from the embodiment described above is essentially that the collection chamber 23 is situated behind the filter unit 25 in the travel direction, which results in a modified conduction of the suction flow 21 in the area of the air ducts, as described below.

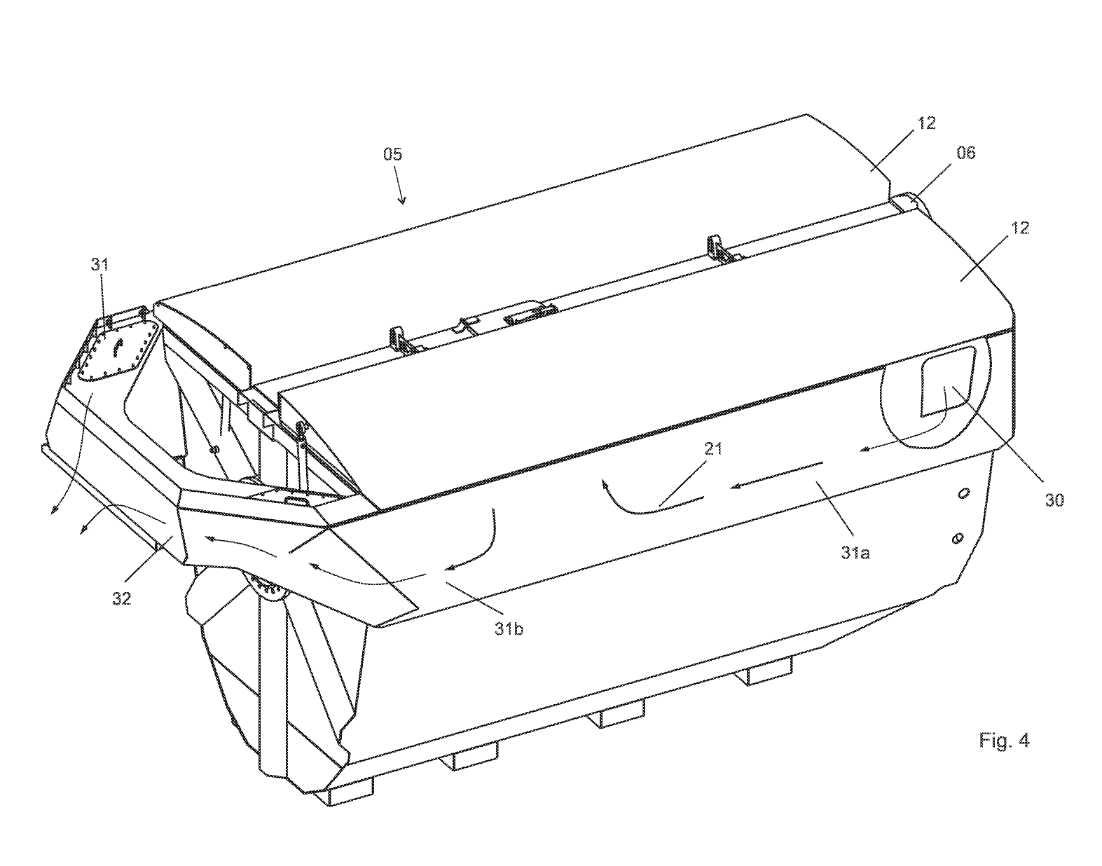

FIG. 4 shows the modified embodiment of the material collection container 05 as used in the embodiment according to FIG. 3. As is apparent from a review of FIGS. 3 and 4, the suction flow 21 initially passes through an upper air duct 27 that is shorter compared to the embodiment in FIG. 1, and after the coarse material 24 is deposited in the collection chamber 23, reaches baffles 28 of a rear pre-separator 29a, situated in the rear area, and via the two side outlets 30 passes into the side air ducts 31. At approximately the front third of the material collection container 05, the suction flow exits from a rear section 31a of the side air ducts and once again passes into the interior, in particular into a front pre-separator 29b, from where it is led into the filter unit 25. After passing through the filter unit 5 [sic; 025], the air stream once again enters the area of the side air duct 31, namely, in a front section 31b, and from there passes to the front air duct 32, where the two substreams are recombined.

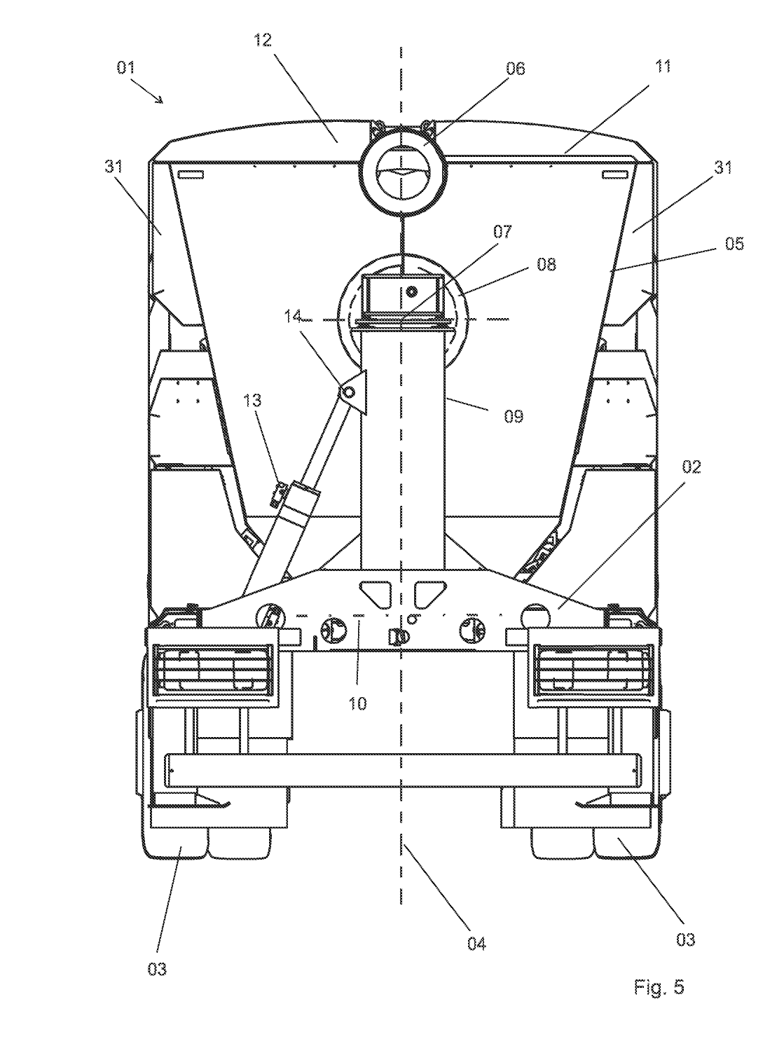

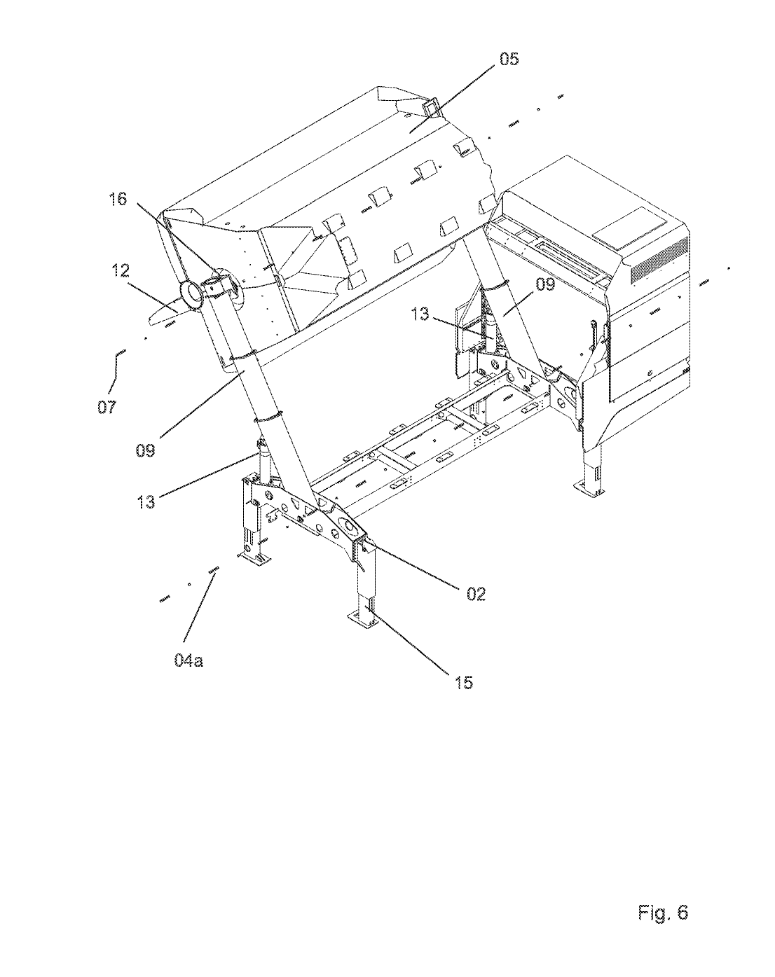

FIG. 5 shows a simplified view of the suction excavator 01 from the rear. With regard to the vehicle wheels 03, the vehicle has a symmetrical design with respect to a vehicle center plane 04, as illustrated by a dash-dotted line in FIG. 5. A vehicle longitudinal axis 04a (FIG. 6) extends in the vehicle center plane. As an add-on element, the suction excavator 01 has the material collection container 05, which may be designed in the form of an emptying module. In this view it is clearly apparent that the suction connection 06 is situated in the middle of the rear end-face wall on the upper edge, so that the midpoint of the cross-sectional area of the suction connection lies in the vehicle center plane 04.

The material collection container 05 is suspended in a tilt axis 07 whose course is defined by two pivot bearings 08 situated on the end-face walls of the material collection container 05 that extend transversely with respect to the travel direction of the suction excavator.

In the embodiment shown, a telescoping device includes two telescoping arms 09 whose ends on the container side are respectively coupled to one of the pivot bearings 08, and whose ends on the chassis side are respectively pivotably mounted on a pivot bearing 10 on the vehicle chassis 02.

It is apparent from FIG. 5 that the material collection container 05 is situated essentially above the vehicle chassis or an auxiliary frame 02 during an idle, transport, or working position. A top side 11 of the material collection container 05 extends essentially horizontally in this state. The top side 11 is closed by the cover 12. The telescoping arms 09 are essentially perpendicular to the plane of the vehicle chassis 02.

A hydraulic cylinder 13 that operates as a slew drive extends between the vehicle chassis 02 and a coupling point 14 on the section of the particular telescoping arm 09 that is not changeable in length. The slew drive 13 is designed in such a way that when actuated, it can swivel the telescoping arm 09 in both angular directions from the vertical position, i.e., out of the vehicle center plane 04 to the left or to the right.

FIG. 6 shows a simplified perspective view of the emptying module as a component of the suction excavator 01 described above. The chassis elements that are part of the suction excavator 01 are for the most part not illustrated in FIG. 6. Portions of the vehicle chassis may be assigned directly to the vehicle and/or to the auxiliary frame of the emptying module, designed as a stand-alone part.

FIG. 6 shows the state of emptying the material collection container 05. For this purpose, the telescoping arms 09 are extended in the longitudinal direction, and after reaching a minimum height that allows swiveling, arc swiveled to one of the two vehicle sides or module sides by activating the slew drive 13. In the illustrated example, the material collection container 05 has been swiveled to the left, based on the travel direction.

To ensure secure positioning of the suction excavator during the emptying operation, stanchions 15 may be extended so that the vehicle is standing in the most horizontal position possible.

After the telescoping arms 09 are axially extended and swiveled, a rotary drive 16, situated in the area of the pivot bearings 08 or integratable into same, is activated. The activation of the rotary drive 16 causes the material collection container 05 to rotate about the tilt axis 07, so that the top side 11 is inclined downwardly and to the side in order to dump the material collected in the material collection container 05, with the cover 12 open.

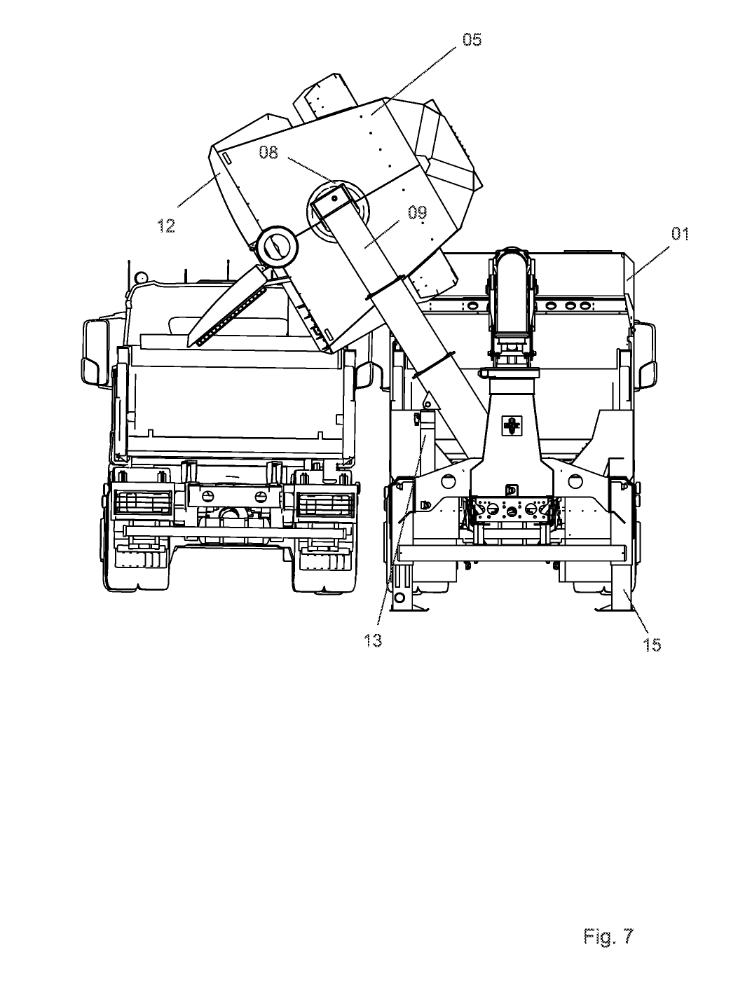

FIG. 7 shows once again the state during emptying of the material collection container 05, in a simplified view from the rear. It is clearly apparent in this illustration that, due to the extension of the telescoping arms 09, the tilt axis 07 is displaced upwardly until the edge of the top side 11, which is situated at the bottom when the material collection container 05 is tipped, may be at a height of 2-3 m, for example, so that it is possible to empty the material collection container 05 into a truck situated next to the vehicle. This requires that the cover 12 is at least partially open. preferably as the result of swiveling a cover half about a folding axis that extends approximately in the centerline of the top side 11.

It is also apparent from FIG. 7 that, due to the lateral swiveling of the telescoping arms 09 with the aid of the slew drive 13, the tilt axis 07 may extend to the left next to the suction excavator, or, for swiveling in the other direction, may extend to the right next to the suction excavator 01. It is thus possible to empty the material collection container 05 on the left side and on the right side of the suction excavator.

The telescoping arms 09 are preferably equipped with an integrated linear guide, and are extendable in and out by hydraulic cylinders in a manner known per se. Concurrent operation of the two telescoping arms is generally possible with appropriate control, and in certain application situations, extension of the two telescoping arms by different amounts may be advantageous.

To avoid torsions, a slew drive 13 is preferably associated with each of the two telescoping arms 09, as is apparent from FIG. 6. These two slew drives 13 are likewise operated synchronously. The stated rotary drive 16 may be situated in each case at the container-side ends of the telescoping arms 09, or it is possible to equip only one of the telescoping arms 09 with the rotary drive, while a journal bearing implements the pivot bearing on the other telescoping arm.

### LIST OF REFERENCE NUMERALS

01 suction excavator
02 vehicle chassis/auxiliary frame
03 vehicle wheels
04 vehicle center plane
04a vehicle longitudinal axis
05 material collection container
06 suction connection
07 tilt axis
08 pivot bearing
09 telescoping arms
10 pivot bearing
11 top side
12 cover
13 slew drive
14 coupling point
15 stanchions
16 rotary drive
20 suction hose
21 suction flow
22 baffle plate
23 collection chamber
24 deposited material
25 filter unit
26 suction fan
27 upper air duct
28 baffles
29 pre-separator
30 side outlet
31 side air duct
32 front air duct
33 inlet of the suction fan

1. A material collection container of a suction excavator comprising:
a suction connection at a rear end-face wall;
a filter unit;
a collection chamber; and
a suction flow duct that leads from the suction connection through the collection chamber and the filter unit,
wherein the suction connection is positioned at the rear end-face wall in such a way that its cross section is intersected by the plane of symmetry of the material collection container, and
wherein after passing through the collection chamber the suction flow is divided into at least two subflows that are conducted in air ducts situated on both sides of the plane of symmetry, wherein the air ducts are combined outside the collection chamber and open into an inlet of a suction fan of the suction excavator.

2. The material collection container according to claim 1, wherein the plane of symmetry of the material collection container in an untipped state of the material collection container coincides with a vehicle center plane of the suction excavator.

3. The material collection container according to claim 1, wherein air ducts situated on both sides of the plane of symmetry extend, in sections, in parallel to the side walls of the collection chamber in the upper third of the material collection container.

4. The material collection container according to claim 1, wherein the collection chamber is situated in front of the filter unit in the travel direction of the suction excavator.

5. The material collection container according to claim 1, further comprising an at least two-part cover, wherein each cover part is rotatably fastened to a folding axis situated in the plane of symmetry of the material collection container.

6. The material collection container according to claim 1, further comprising a pivot bearing on each of its two end-face sides that allows a suspension of the material collection container in a tilt axis that extends in the plane of symmetry.

7. A suction excavator having:
a vehicle chassis, wherein a vehicle longitudinal axis of the vehicle extends in a vehicle center plane;
a dumpable material collection container suspended in a tilt axis extending in parallel to the vehicle longitudinal axis,
wherein the dumpable material collection container comprises:
a suction connection at a rear end-face wall;
a filter unit;
a collection chamber; and
a suction flow duct that leads from the suction connection through the collection chamber and the filter unit,
wherein the suction connection is positioned at the rear end-face wall in such a way that its cross section is intersected by the plane of symmetry of the material collection container, and
wherein after passing through the collection chamber the suction flow is divided into at least two subflows that are conducted in air ducts situated on both sides of the plane of symmetry, wherein the air ducts are combined outside the collection chamber and open into an inlet of a suction fan of the suction excavator.

8. The suction excavator according to claim 7, wherein the tilt axis extends in the plane of symmetry of the dumpable material collection container, which in an untipped state coincides with the vehicle center plane and further comprises:
a telescoping device that has two telescoping arms whose ends on the container side are each situated on the tilt axis about which the dumpable material collection container is rotatable, and whose ends on the chassis side are each pivotably fastened to the vehicle chassis in the vehicle center plane;
at least one rotary drive is situated on the container-side end of at least one telescoping arm to allow a rotation of the material collection container about the tilt axis; and
at least one slew drive which allows the telescoping arms to swivel out of the vehicle center plane in both angular directions.

9. The suction excavator according to claim 8 wherein the swiveling of the telescoping arms is at least wide enough that the projected tilt axis extends outside the surface area described by the vehicle chassis.

10. The material collection container according to claim 2, wherein air ducts situated on both sides of the plane of symmetry extend, in sections, in parallel to the side walls of the collection chamber in the upper third of the material collection container.

11. The material collection container according to claim 2, wherein the collection chamber is situated in front of the filter unit in the travel direction of the suction excavator.

12. The material collection container according to claim 3, wherein the collection chamber is situated in front of the filter unit in the travel direction of the suction excavator.

13. The material collection container according to claim 1, wherein the collection chamber is situated behind the filter unit in the travel direction of the suction excavator.

14. The material collection container according to claim 2, wherein the collection chamber is situated behind the filter unit in the travel direction of the suction excavator.

15. The material collection container according to claim 3, wherein the collection chamber is situated behind the filter unit in the travel direction of the suction excavator.

16. The material collection container according to claim 2, further comprising an at least two-part cover, wherein each cover part is rotatably fastened to a folding axis situated in the plane of symmetry of the material collection container.

17. The material collection container according to claim 3, further comprising an at least two-part cover, wherein each cover part is rotatably fastened to a folding axis situated in the plane of symmetry of the material collection container.

18. The material collection container according to claim 4, further comprising an at least two-part cover, wherein each cover part is rotatably fastened to a folding axis situated in the plane of symmetry of the material collection container.

19. The material collection container according to claim 2 further comprising a pivot bearing on each of its two end-face sides that allows a suspension of the material collection container in a tilt axis that extends in the plane of symmetry.

20. The material collection container according to claim 5 further comprising a pivot bearing on each of its two end-face sides that allows a suspension of the material collection container in a tilt axis that extends in the plane of symmetry.
